(19) United States
(12) Patent Application Publication
(10) Pub. No.: US 2006/0140712 A1
(43) Pub. Date: Jun. 29, 2006

(54) Gas spring ball joint and method for manufacturing the same

(75) Inventors: Cheolgon Sun, Gimhae-si (KR); Joon-Jae Lee, Yangsan-si (KR); Dong-Woog Oh, Gimhae-si (KR)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: SUN PREIN CO., LTD., Gimhae-si (KR)

(21) Appl. No.: 11/339,902

(22) Filed: Jan. 26, 2006

Related U.S. Application Data
(63) Continuation-in-part of application No. 11/023,656, filed on Dec. 28, 2004.

(30) Foreign Application Priority Data
Jun. 17, 2005 (KR) 2005-0052553

(51) Int. Cl. F16C 11/00

(52) U.S. Cl. 403/135

(57) ABSTRACT

A ball joint of a gas spring and a method for manufacturing the ball joint are disclosed. A gap preventing member is mounted to a support ball of a ball stud inserted into a ball insertion recess of an end socket and an adhering member which adheres the gap preventing member is provided, so that the ball joint maintains the operational force normally even after the generation of wear due to a long time use. Further, by manufacturing the ball joint by pressing and welding, the manufacturing cost is reduced and the manufacturing process is simplified.

### CROSS-REFERENCE TO RELATED APPLICATION

This application is a continuation-in-part of U.S. application Ser. No. 11/023,656, filed on Dec. 28, 2004, and claims the benefit of Korean patent application no. 2005-0052553, filed Jun. 17, 2005. Both of the aforesaid applications are incorporated herein by reference in their entirety.

### TECHNICAL FIELD

The present invention relates to a ball joint of a gas spring, and more particularly, to a ball joint of a gas spring that is configured to prevent the formation of a gap and to maintain normal operational force even after long time use.

### BACKGROUND

Gas springs, in which a cylinder is filled with gas or oil and a piston rod is engaged with the interior of the cylinder, have been used in vehicle seats, including automobiles and airplanes. These gas springs generally include ball joints. An example of a conventional gas spring ball joint is shown in FIG. 1. The conventional gas spring 1 has end sockets 2 with ball insertion recesses 2a formed at both ends of the gas spring 1. A support ball 5 of a ball stud 6 is inserted into the ball insertion recess 2a formed in the end socket 2 so that the support ball 5. A C-ring 7 prevents the support ball 5 from deviating. The gas spring 1 also includes a bolt portion 3 and a nut portion 4.

However, since the ball joint of the conventional gas spring is manufactured by hot rolling or injection molding, the interval of the support ball 5 of the ball stud 6 cannot arbitrarily be regulated in the interiors of the ball insertion recesses 2a of the end sockets 2. Therefore, when the gap of the support ball 5 is large, excess noise is generated during the operation of the gas spring. Furthermore, after the ball joint is used for a long time, the portion that makes contact with the end socket becomes worn, and the ability for the device to prevent the generation of a gap is degraded.

Finally, manufacturing the end sockets 2 is complicated and expensive because it requires cooling forging and lathing, and because it needs to be accurately machined to the correct size.

### SUMMARY OF THE INVENTION

Accordingly, the present invention has been made to solve the above-mentioned problems occurring in the prior art. An embodiment of the present invention is to provide a ball joint of a gas spring that prevents the generation of a gap in a state in which a support ball of a ball stud is engaged with the ball joint of the gas spring.

In another embodiment a ball joint is provided that can be normally operated even after the generation of wear due to a long time and repetitive use.

Another embodiment of the present invention provides a method for manufacturing a ball joint of a gas spring that can reduce the manufacturing cost and is simple.

In still another embodiment, there is provided a ball joint of a gas spring comprising: a gas spring body, an end socket provided at one end of the gas spring body and having a ball insertion recess with upper and lower portions thereof opened; a ball stud having a support ball inserted into the interior of the ball insertion recess of the end socket; a gap preventing member interposed between the ball insertion recess of the ball joint and the support ball of the ball stud, for preventing a gap between the support ball and the ball insertion recess; an adhering member for adhering the gap preventing member to the support ball of the ball stud; and a fixing member installed on the inner side of an ball insertion opening of the ball insertion recess, for preventing the deviation of the gap preventing member.

### BRIEF DESCRIPTION OF THE DRAWINGS

The above and other objects, features and advantages of the present invention will be more apparent from the following detailed description taken in conjunction with the accompanying drawings, in which:

FIG. 1 is a cross-sectional view for showing a structure of a ball joint of a conventional gas spring;

FIG. 2 is a front view for showing a gas spring according to the present invention;

FIG. 3 is a cross-sectional view for showing a structure of a ball joint of a gas spring according to a preferred embodiment of the present invention;

FIG. 4 is an exploded perspective view for showing a structure of a ball joint of a gas spring of FIG. 3;

FIG. 5 is a cross-sectional view for showing a structure of a ball joint of a gas spring according to another preferred embodiment of the present invention;

FIG. 6 is an exploded perspective view for showing a structure of a ball joint of a gas spring of FIG. 5;

FIG. 7 is a process chart for explaining a manufacturing process of an end socket which is a ball joint of a gas spring according to the present invention; and

FIG. 8 is a view for sequentially showing process states of FIG. 7.

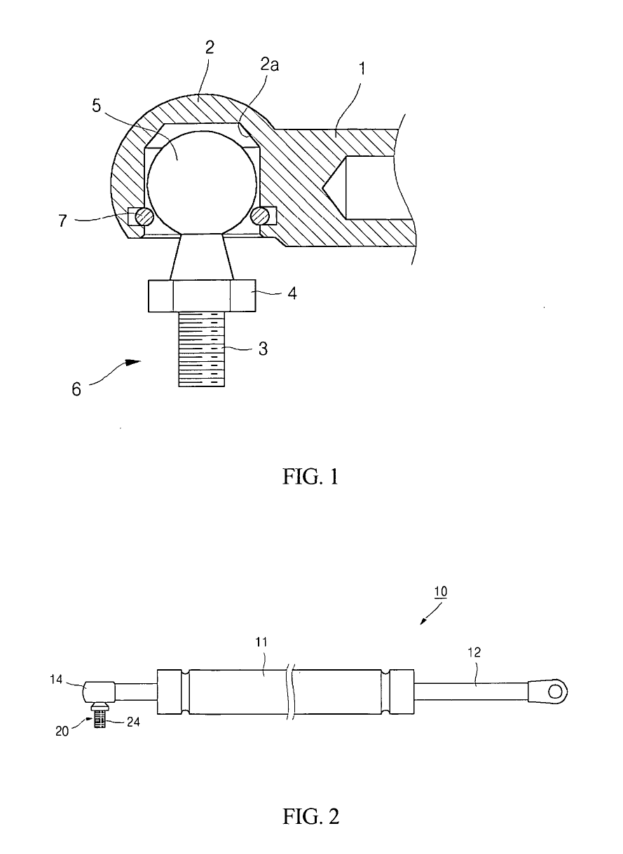

### DETAILED DESCRIPTION

Referring to FIG. 2, a gas spring 10 configured according to an embodiment of the invention is shown. The gas spring 10 includes a cylinder 11 and a piston rod 12 protruding from the upper end of the cylinder 11. A ball stud 20 is engaged with one end of the gas spring 10, and an end socket 14 is provided as a hinge member that is part of a ball joint.

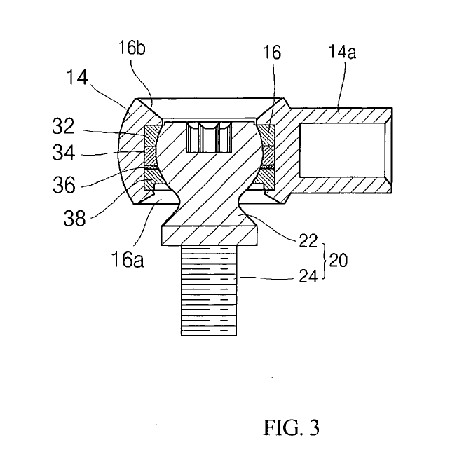

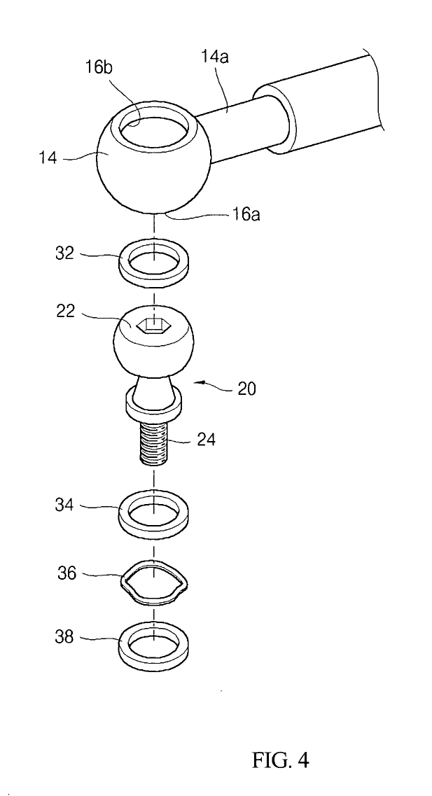

Referring to FIGS. 3 and 4, the ball joint assembly of the gas spring 10 is shown. The ball joint assembly includes a ball insertion recess 16 formed in the end socket 14. The ball joint assembly further includes a ball insertion opening 16a that is formed on one side of the ball insertion recess 16, and into which a support ball 22 of the ball stud 20 is inserted. An opened portion 16b is formed on the side opposite to the ball insertion opening 16a.

Upper and lower backup rings 32 and 34 are provided for preventing the formation of a gap between the support ball 22 and the inner surface of the ball insertion recess 16.

A wave washer 36 for resiliently supporting the upper and lower backup rings 32 and 34 is installed at the lower end of the lower backup ring 34.

Further, an inner washer 38 for supporting the wave washer 36 and preventing the deviation of the wave washer 36 is installed at the lower end of the wave washer 36.

The ball stud 20 includes a support ball 22 and a bolt portion 24 formed on the other side of the support ball 22. A flat surface is formed in the support ball 22 by cutting an upper portion of the support ball 22 to define an engaging recess at the central portion of the flat surface. An engaging tool is inserted into the engaging recess to engage the bolt portion 24 of the ball stud.

According to an embodiment of the invention, the ball joint assembly of the gas spring according is assembled in the following manner. First, the upper backup ring 32 is inserted into the ball insertion recess 16. Then, the support ball 22 of the ball stud 20 is inserted into the ball insertion recess 16. Then, the lower backup ring 34 and the wave washer 36 are sequentially mounted onto the outer peripheral surface of the support ball 22 of the ball stud 20, and the support ball 22 of the ball stud 20 is inserted through the ball insertion opening 16a of the ball insertion recess 16.

After the support ball 22 of the ball stud 20 is inserted into the ball insertion recess 16, the inner washer 38 is caulked to and fixed to the inner surface of the ball insertion recess 16. Then, the support ball 22 of the ball stud 20 is rotatably engaged in the ball insertion recess 16 of the end socket 14 such that the generation of a gap is prevented by the upper and lower backup rings 32 and 34.

Further, since the wave washer 36 adheres the upper and lower backup rings 32 and 34 to the support ball 22 of the ball stud 20, even after the upper and lower backup ring 32 and 34 are worn after a long time and repetitive use, the adhering force between the upper and lower backup rings 32 and 34 and the support ball 22 is maintained and the operational force of the joint is continuously maintained. Also, the inner washer 38 supports the waver washer 36 and prevents the upper and lower backup rings 32 and 34 and the wave washer 36 from being deviated from the ball insertion recess 16.

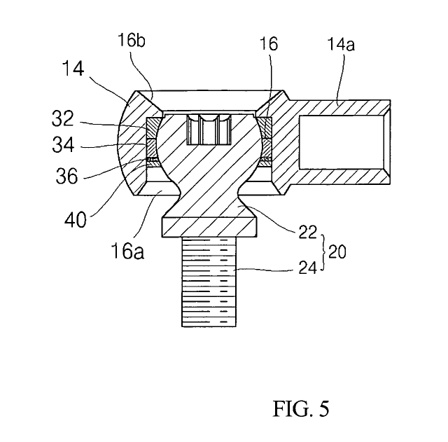

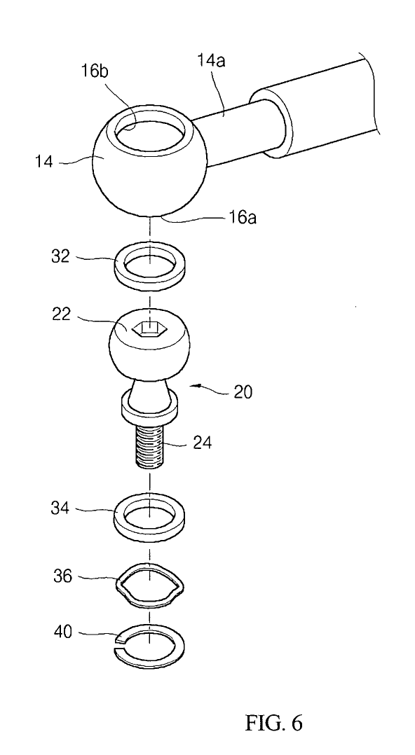

According to another embodiment of the invention, as shown in FIGS. 5 and 6, the upper and lower backup rings 32 and 34 are mounted on the inner side of the ball insertion recess 16 of the end socket 14. A snap ring 40 is caulked and assembled to the lower side of the wave washer 36, so that the upper and lower backup rings 32 and 34 and the wave washer 36 are prevented from being separated from the inner side of the ball insertion recess 16. In other respect, the operation of the ball joint in the embodiment of FIGS. 5 & 6 is same as that of the embodiment of FIGS. 3 and 4.

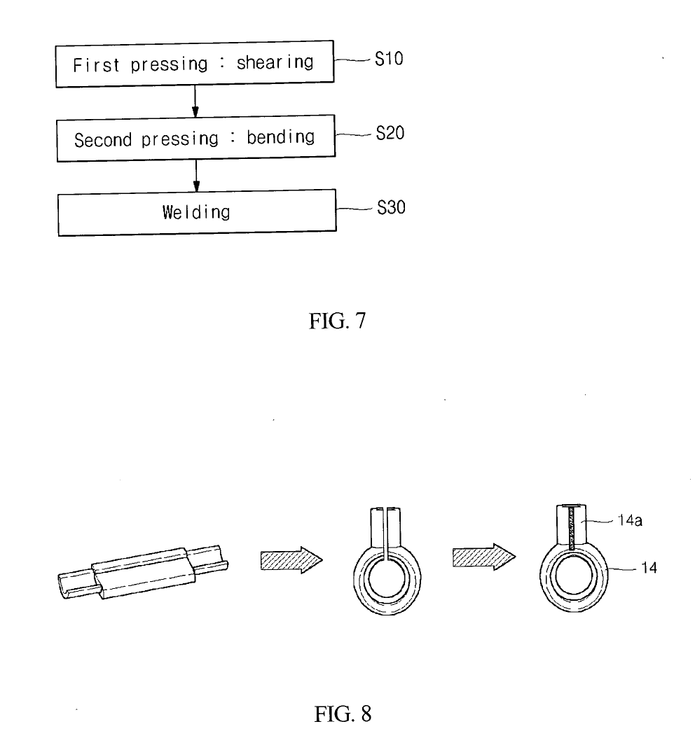

Referring to FIG. 7, a method for manufacturing a ball joint of a gas spring according to an embodiment of the invention will now be described. The method comprises the steps of: shearing a material so that the material is cut so as to have the length of an end socket (S10), then bending or folding the end socket so that the central portion of the cut end socket is folded to form a circular or ball-shaped insertion recess into which a support ball of a ball stud can be inserted (S20), and, finally, welding the end socket 14 so that both neck portions 14a of the end socket are bonded (S30). The welding step may be accomplished, for example, by CO2 welding.

Thus, since the upper and lower ends of the end socket 14 are in communication with the ball insertion opening 16a and the opened portion 16b, the end socket 14 can be conveniently manufactured by press machining (to shear and bend) and by welding. This reduces the manufacturing cost and simplifies the manufacturing process, thereby improving productivity.

As discussed above, gas spring ball joint of an embodiment of the invention prevents formation of a gap is prevented, which reduces noise and leads to smooth operation. Furthermore, even if the gap preventing member is worn after long term use, the support ball maintains normal operation because of the adhering member. Furthermore, since the ball joint is manufactured by press machining and welding, the overall manufacturing cost is reduced and simplified.

Although embodiments of the present invention have been described for illustrative purposes, those skilled in the art will appreciate that various modifications, additions and substitutions are possible without departing from the scope and spirit of the invention as disclosed in the accompanying claims.

What is claimed is:

1. A ball joint assembly for a gas spring, the ball joint assembly comprising:
a ball joint comprising an inner wall that defines a cavity having at least one open end;
a ball stud comprising a support ball, the ball stud being coupled to the ball joint such that at least a portion of the support ball is disposed within the cavity;
a gap preventing member disposed between the inner wall and the support ball to inhibit movement of the support ball relative to the inner wall;
a support member installed on the inner wall proximate to the gap preventing member, wherein the support member prevents the gap preventing member from leaving the cavity; and
a means for reinforcing the support member, wherein the reinforcing means is disposed between the support member and the open end.

2. The ball joint assembly of claim 1, wherein the gap preventing member is one of a plurality of gap preventing members.

3. The ball joint assembly of claim 2, wherein the gap preventing member is a first gap preventing member disposed around the support ball, wherein the ball joint assembly further comprises a second gap preventing member disposed between the inner ball and the support ball, the second gap preventing member being proximate to the first gap preventing member.

4. The ball joint assembly of claim 1, wherein the support member is chosen from the group consisting of a washer and a snap ring.

5. The ball joint assembly of claim 1, wherein the reinforcing means comprises a washer mounted to the gap preventing member.

6. The ball joint assembly as claimed in claim 1,
wherein the support ball has a substantially planar, upper surface,
wherein a coupling recess is defined within the upper surface of the support ball, and
wherein the coupling recess is aligned with the opening at the top of the cavity so as to allow a worker to couple a tool to the coupling recess via the opening at the top of the cavity.

7. The ball joint assembly as claimed in claim 5, wherein the coupling recess is formed proximate to the center of the upper surface.

8. A method for manufacturing a ball joint of a gas spring, the method comprising:
shearing a material so that the material is cut so as to have the length of an end socket of the ball joint;
bending the material so that a first and a second edge of the material meet to form a ball insertion recess;
inserting a support ball of a ball stud into the ball insertion recess; and
welding the first and second edges together.

9. The method of claim 8, further comprising inserting an upper backup ring into the ball insertion recess.

10. The method of claim 8, further comprising sequentially mounting a lower backup ring and a washer onto the outer peripheral surface of the support ball.

11. The method of claim 8, further comprising caulking an inner washer to an inner surface of the ball insertion recess.

12. A method for manufacturing a gas spring, the gas spring comprising a cylinder, a piston rod coupled to the cylinder, the piston rod having a support ball, a ball joint assembly having an inner wall defining a cavity that is open at its bottom, the support ball being disposed within the cavity, a gap prevention means, and a fixing means, the method comprising:
shearing a material so that the material is cut so as to have the length of the cavity;
bending the material so that a first and a second edge of the material meet to form the inner wall;
inserting the support ball into the cavity; and
welding the first and second edges together.

13. The method of claim 12, wherein the gap prevention means is a ring, the method further comprising inserting the ring such that it is disposed around the support ball and makes substantial contact with both the ball stud and the inner wall.

14. The method of claim 12, wherein the gap prevention means is a first gap preventing member disposed around the support ball, the method further comprising inserting a second gap preventing member into the cavity such that the second gap preventing member is disposed between the inner wall and the support ball, the second gap preventing member being proximate to the first gap preventing member.

15. The method of claim 12, further comprising inserting an upper backup ring into the cavity.

16. The method of claim 12, further comprising sequentially mounting a lower backup ring and a washer onto the outer peripheral surface of the support ball.

17. The method of claim 12, further comprising caulking an inner washer to the inner wall.

18. A gas spring comprising:
a cylinder;
a piston rod having a first end and a second end, the first end being disposed within the cylinder, the second end comprising an inner wall defining a ball insertion recess open at its top and its bottom;
a ball stud including a support ball and a bolt portion, the support ball being disposed within the ball insertion recess, the bolt portion being disposed outside of the ball insertion recess;
an upper and a lower backup ring disposed between the support ball and the inner wall for preventing the formation of a gap between the support ball and the inner wall;
a wave washer supporting the upper and lower backup rings, the wave washer being installed at a lower end of the lower backup ring; and
a means for inhibiting movement of the wave washer, the inhibiting means being installed at the lower end of the wave washer,
wherein a flat surface is formed in the support ball, an engaging recess being defined within a central portion of the flat surface, the engaging recess being adapted to receive an engaging tool.

19. The gas spring of claim 18, wherein the inhibiting means is an inner washer caulked to the inner wall.

20. The gas spring of claim 18, wherein the inhibiting means is a snap ring caulked and assembled to the wave washer.
